(19) United States
(12) Patent Application Publication
(10) Pub. No.: US 2016/0092160 A1
(43) Pub. Date: Mar. 31, 2016

(54) USER ADAPTIVE INTERFACES

(71) Applicant: Intel Corporation, Santa Clara, CA (US)

(72) Inventors: Peter Graff, San Jose, CA (US); Ana Paula Quirino Simoes, Palo Alto, CA (US); Crystal A. Nakatsu, Santa Clara, CA (US); Jessica M. Christian, Redwood City, CA (US)

(21) Appl. No.: 14/497,984

(22) Filed: Sep. 26, 2014

(51) Int. Cl. G06F 3/16; G10L 15/26; G10L 15/22; G10L 13/04; G10L 15/187

(52) U.S. Cl. CPC G06F 3/167; G10L 13/043; G10L 15/187; G10L 15/22; G10L 15/265; G10L 2015/223

(57) ABSTRACT

Systems and methods for providing a user adaptive natural language interface are disclosed. The disclosed embodiments may receive and analyze user input to derive current user behavior data, including data indicative of characteristics of the user input. The user input is classified based on prior user behavior data previously logged during one or more previous user-system interactions and the current user behavior data to generate a classification of the user input. Machine learning algorithms can be employed to classify the user input. User adaptive utterances are selected based on the user input and the classification of the user input. The user-system interaction is logged for use as prior user behavior data in future user-system interactions. A response to the user input is generated, including synthesizing output speech from the user adaptive utterances selected. Example applications of the disclosed systems and methods provide user adaptive navigation directions in navigation systems.

### TECHNICAL FIELD

Embodiments herein relate generally to user adaptive interfaces.

### BACKGROUND

Natural language interfaces are becoming commonplace in computing devices generally, and particularly in mobile computing devices, such as smartphones, tablets, and laptop computers. A natural language interface (NLI) may enable a user to interact with a computing device using natural language (spoken words), rather than typing text, using a mouse, touching a screen, or other input modes. The user can simply say common everyday words and phrases, and the NLI will detect, analyze, and react to the input. Even where an NLI may require and/or accept text input, the NLI may provide audible output speech. The reaction may include providing an appropriate verbal (synthesized speech) or textual response. Presently, NLI technology provides responses that are static, in the sense that NLIs generally respond to substantially similar user input the same way each time.

As an example, if a user provides a request to an NLI such as “Would you kindly send an email for me?”, the response from the NLI may be “To whom would you like me to send this message?” or “To whom should I send it?” The response from the same NLI would be substantially the same every time, whether the user used the input “Would you kindly send an email for me?,” the more succinct input “Send an email,” or the even more terse input “Send email.”

As another example, if a user asks a navigation system for directions from his/her home to a particular location, a presently available navigation system interface would provide the same, or substantially similar, directions to a point away from the vicinity of the user's home (e.g., a point out of the user's neighborhood). Regardless of how familiar the territory may be to the user, the navigation system interface may provide identical directions from the user's home to the nearest interstate freeway on-ramp. A presently available navigation system interface simply does not consider that the user may be familiar with the area and likely has learned the way from home to the interstate freeway during the many years that the user has lived in the area and/or the multiple interactions in which the navigation system interface has provided the same directions to the interstate freeway.

### BRIEF DESCRIPTION OF THE DRAWINGS

FIG. 1 is a schematic diagram of a system for providing a user adaptive natural language interface, according to one embodiment of the present disclosure.

FIG. 2 is a schematic diagram of an adaptive utterances engine of a system for providing a user adaptive natural language interface, according to one embodiment.

FIG. 3 is a flow diagram of a method for providing a user adaptive natural language interface, according to one embodiment of the present disclosure.

FIG. 4 is a schematic diagram of a system for providing user adaptive directions in a navigation system, according to one embodiment of the present disclosure.

### DETAILED DESCRIPTION OF PREFERRED EMBODIMENTS

Natural language interface (NLI) technology is presently available on a variety of computing devices generally, and particularly in mobile computing devices, such as smartphones, tablets, and laptop computers. Presently, NLI technology provides output speech that is static. In other words, NLI technology provides responses that are static in the sense that a response to substantially similar input speech is, in essence, the same each time. Different variations of input speech that intend a similar response (e.g., “Would you kindly send an email for me?,” “Send an email,” or “Send email”) would elicit, from the same NLI, a substantially identical response in each case. The NLI does not consider past interactions with the same user. Further, presently available NLI technology does not change a style or verbosity of output speech based on how the user speaks the input speech.

Consider that speech to a close friend may be different from speech to a new business colleague, due to different expectations, unfamiliarity with the business colleague, and uncertainty how the new business colleague may respond. The speech may vary in terms of style (e.g., level of formality), verbosity (e.g., quantity of words, level of detail, degree of descriptiveness), the way in which individual words or sequences of words are pronounced (e.g., I wanna meet her vs. I want to meet her), the particular words a speaker chooses (e.g., I met her vs. I encountered her), and the particular sequences of words used to convey a given meaning (e.g., John kicked the cat vs. the cat was kicked by John). Presently available NLI technology does not consider characteristics of input speech to provide user adaptive responses.

An illustrative example of the shortcomings of presently available NLI technology is in navigation systems. Regardless of how familiar a given territory may be to the user, presently available NLI technology provides substantially identical directions from the user's home to the nearest interstate freeway on-ramp, failing to consider that the user may be familiar with the area and likely has learned the way from home to the interstate freeway during the many years that the user has lived in the area, or from multiple previous interactions in which the NLI has provided the directions to the interstate freeway. Navigation systems that do not include NLI, but provide another type of interface (e.g., visual), suffer similar shortcomings.

Some NLI technology may have a few response options, but these options are static and simply rotate or change periodically, generally based on an internal factor such as a timer or counter. These changes to the response are not based on varying forms or characteristics of input speech. In short, presently available NLI technology is not adaptive in responding to user input (e.g., user speech, user behavior).

The present inventors have recognized that providing user adaptive NLI technology can improve user experience. NLI technology that adapts its behavior for a given user can provide responses that are better suited for (e.g., more palatable, acceptable, satisfactory to) the given user.

The disclosed embodiments provide a dynamic approach to presenting output, such as output speech in an NLI. The disclosed embodiments may log user behavior and/or user-system interactions, including but not limited to frequency of occurrence, linguistic content, style, duration, workflow, information conveyed, etc. A model may be created for a given user to allow adaptation of output behavior for the given user. The model may characterize the user based on, for example, usage patterns, linguistic choices made by the user, quantity and/or nature of successful and unsuccessful interactions, and user settings. Based on these factors, the disclosed embodiments may be classified and the classification can enable adapting output speech to a user by, for example, changing word choice, changing speech register(s), changing verbosity, simplifying procedures and/or interactions, and/or assuming input unless provided otherwise.

The model to characterize the user may account for variations in speech that go beyond the specific words or sequences of words chosen. Specifically, the model may also take advantage of non-lexical cues employed in language. Examples of such cues include but are not limited to pitch (John is French! Vs. John is French?), stress (he's a CONvict, vs. judges conVICT), length of various linguistic constituents, pauses and timing, filled pauses (e.g., John is ummm a friend) and other disfluencies (e.g., Did uh did you say banana?). What constitutes a non-lexical cue may depend upon a given language, including a dialect of a language. In some sense, any linguistic feature may be a non-lexical cue and may be analyzed to classify speech. Input speech to NLI technology may be analyzed to identify linguistic features and/or non-lexical cues and to enhance classification of the input speech. As previously noted, response utterances can be adapted based on that input speech classification to provide an adaptive NLI.

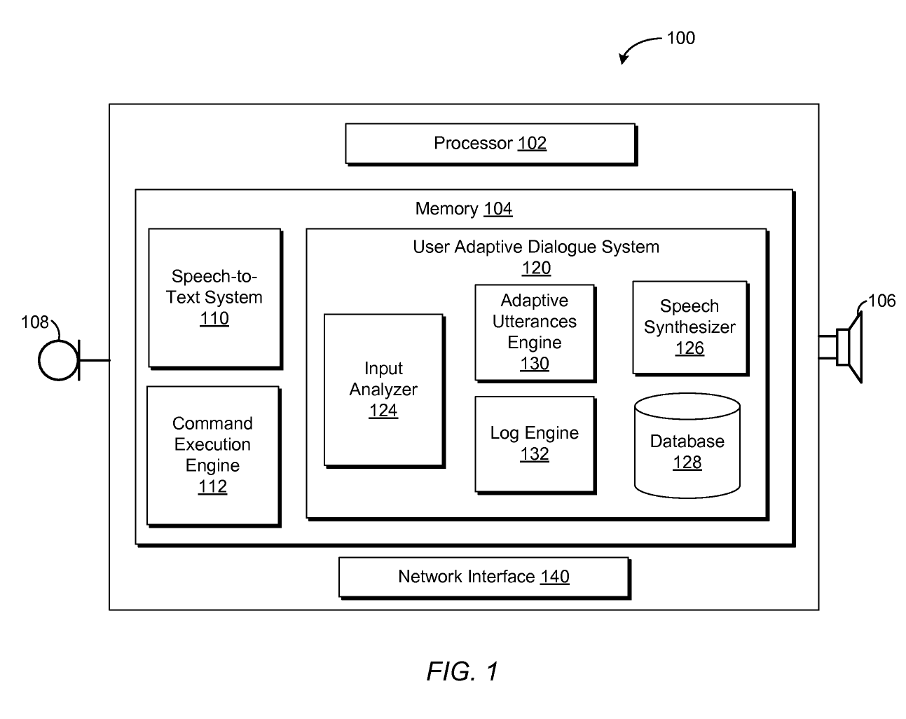

FIG. 1 is a schematic diagram of a system 100 for providing a user adaptive NLI, according to one embodiment. The system 100 may include a processor 102, memory 104, an audio output 106, an input device 108, and a network interface 140. The processor 102 may be a dedicated to the system 100 or may be incorporated into and/or borrowed from another system or computing device, such as a desktop computer or a mobile computing device (e.g., laptop, tablet, smartphone, or the like). The memory 104 may be coupled to or otherwise accessible by the processor 102. The memory 104 may include and/or store protocols, modules, tools, data, etc. The audio output 106 may be a speaker to provide audible synthesized output speech. In other embodiments, the audio output 106 may be an output port to transmit a signal including audio output to another system. The input device 108 may be a microphone, as illustrated. In other embodiments, the input device 108 may be a keyboard or other input peripheral (e.g., mouse, scanner). In still other embodiments, the input device 108 may simply be an input port configured to receive an input signal transmitting text or input speech. The input device 108 may include or couple to the network interface 140 to receive text data from a computer network.

The system 100 may further include a speech-to-text system 110 (e.g., an automatic speech recognition or “ASR” system), a command execution engine 112, and a user adaptive dialogue system 120.

The system 100 may include a speech-to-text system 110 to receive input speech (e.g., an input audio waveform) and convert the audio waveform to text. This text may be processed by the system 100 and/or another system to process commands and/or perform operations based on the speech-to text output. The speech-to-text system 110 may identify speech registers in the input speech. The speech registers may be communicated to a user adaptive dialogue system 120, which may use the speech registers to derive user behavior, as will be discussed below.

The system may also include a command execution engine 112 configured to execute commands based on the user input (e.g., input speech, input text, other input). The command execution engine 112 may, for example, launch another application (e.g., an email client, a map application, an SMS text client, a browser, etc.), interact with other systems and/or system components, query a network (e.g., the Internet) via a network interface 140, and the like.

The network interface 140 may couple the system 100 to a computer network, such as the Internet. In one embodiment, the network interface 140 may be a dedicated network interface card (NIC). The network interface 140 may be dedicated to the system 100 or may be incorporated into and/or borrowed from another system or computing device, such as a desktop computer or a mobile computing device (e.g., laptop, tablet, smartphone, or the like).

The system 100 may include a user adaptive dialogue system 120 to generate a user adaptive response to the user input (e.g., input speech, input text). The user adaptive dialogue system 120 may also include one or more of the foregoing described components, including but not limited to the speech-to-text system 110, the command execution engine 112, and the like. In the illustrated embodiment of FIG. 1, the user adaptive dialogue system 120 may include an input analyzer 124, an adaptive utterances engine 130, a log engine 132, a speech synthesizer 126, and/or a database 128.

The user adaptive dialogue system 120 provides a user adaptive NLI that adapts its behavior for a given user. The user adaptive dialogue system 120 may be a system for providing a user adaptive NLI, for example, for a computing device. The user adaptive dialogue system 120 may determine and log user behavior and/or user-system interactions. The user behavior may include frequency of use or occurrence of linguistic features, linguistic content, style, duration, workflow, information conveyed, etc. The user adaptive dialogue system 120 may develop and/or employ a model using machine learning algorithms. For example, the user adaptive dialogue system 120 may employ regression analysis, maximum entropy modeling, or another appropriate machine learning algorithm. The model may allow the NLI to adapt its behavior for the given user. The model may characterize the user based on, for example, usage patterns, linguistic choices made by the user, quantity and/or nature of successful and unsuccessful interactions, and user settings. Based on these factors, the user adaptive dialogue system 120 may be able to adapt to a user by, for example, changing word choice, changing speech register(s), changing verbosity, simplifying procedures and/or interactions, and/or assuming input unless provided otherwise.

The system 100 may include an input analyzer 124 to analyze user input received by the system 100. Analysis of the user input by the input analyzer 124 may initiate a user-system interaction. The input analyzer 124 may derive a meaning of the user input. Deriving the meaning may include identifying commands and/or queries and an intended result and/or response to the commands and/or queries. The meaning may be derived from text input or manipulation of a user interface input component (e.g., radio button, check box, list box, and the like). In other embodiments, the input analyzer 124 may include the speech-to-text system 110 to convert user input speech to text.

The input analyzer 124 may also derive current user behavior data. The input analyzer 124 may analyze the user input to determine linguistic features of the input speech. The current user behavior data may include the identified linguistic features and/or non-lexical cues. The current user behavior data may also include identification of linguistic choices, including but not limited to word choice, style, phonetic reduction or enhancement, pitch, stress, and length. The current user behavior data may also include user settings. For example, a user may configure the system to give terse and succinct responses, while another user may prefer the system to respond with great detail and embellishment (e.g., “4 pm” vs. “Sure, I can tell you what time it is. It's 4 pm”). As another example, a user may configure the system in a basic mode that provides ample detail versus an expert mode that assumes the user knows many of the details. The current user behavior data may also include frequency of use or frequency of occurrence of linguistic features.

The system 100 may include an adaptive utterances engine 130. The adaptive utterances engine 130 may utilize machine learning algorithms to consider the prior user behavior data and the current user behavior data to determine a classification of the user input and to select adaptive utterances in response to the user input. The adaptive utterances engine 130 may consider user behavior that may be characterized based on a number of factors, including frequency of use or occurrence of linguistic features, linguistic content, style, duration, workflow, information conveyed, etc.

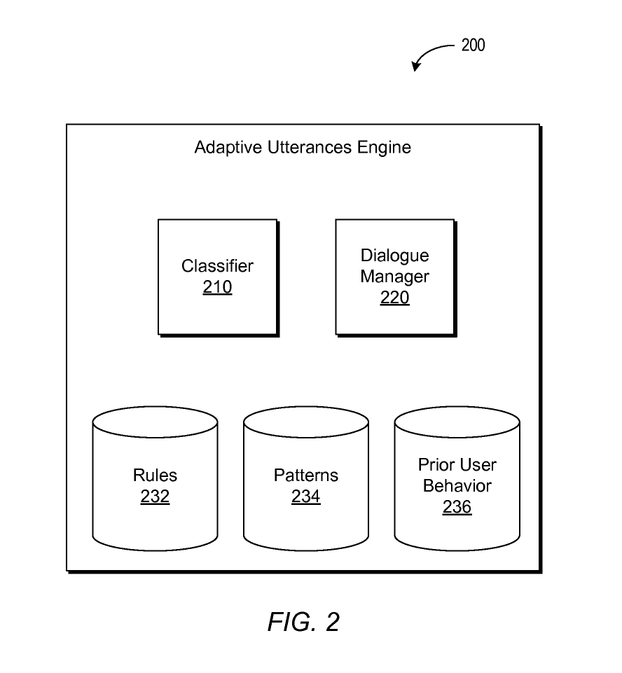

The adaptive utterances engine 130 may develop and/or employ a model using machine learning algorithms. For example, the adaptive utterances engine 130 may employ regression analysis, maximum entropy modeling, or another appropriate machine learning algorithm. The model may allow the NLI to adapt its behavior for the given user. The model may characterize the user based on the current user behavior data, including, for example, usage patterns, linguistic choices made by the user, quantity and/or nature of successful and unsuccessful interactions, and user settings. The characterization may allow classifying the user input. The classification may be used by the adaptive utterances engine 130 to select adaptive utterances as a response to the user input. The adaptive utterances may be adaptive because they change one or more of a word choice, speech register(s), verbosity, simplicity or complexity of procedures and/or interactions, and/or assumption(s) regarding information. An embodiment of an adaptive utterances engine is discussed more fully below with reference to FIG. 2.

The system 100 may include a log engine 132 to log user-system interactions. The logging by the log engine 132 may include logging current user behavior data. In other words, the log engine 132 may log linguistic features and/or speech registers of the user input. The logged user behavior data from a current user-system interaction can then be used (as prior user behavior data) by the adaptive utterances engine 130 during a future user-system interaction.

The speech synthesizer 126 can synthesize speech from the selected adaptive utterances selected by the adaptive utterances engine 130. The speech synthesizer may include any appropriate speech synthesis technology. The speech synthesizer 126 may generate synthesized speech by concatenating pieces of recorded speech that are stored in the database 128. The pieces of recorded speech stored in the database 128 may correspond to words and/or word portions corresponding to potential adaptive utterances. The speech synthesizer 126 may retrieve or otherwise access stored recordings of speech units—complete words and/or word parts, such as phones or diphones—stored in the database 128 and concatenate the recordings together to generate synthesized speech. The speech synthesizer 126 may be configured to convert text adaptive utterances into synthesized speech.

The database 128 may store recordings of speech units, as previously noted. The database 128 may also store data used by the adaptive utterances engine 130 to classify user input, including but not limited to usage patterns, linguistic choices made by the user, quantity and/or nature of successful and unsuccessful interactions, and user settings.

FIG. 2 is a schematic diagram of an adaptive utterances engine 200 of a system for providing a user adaptive NLI, according to one embodiment. The adaptive utterances engine 200 includes a classifier 210 and a dialogue manager 220. The adaptive utterances engine 200 may consider current user behavior data in the context of prior user behavior data 236 and/or other considerations, such as rules 232 (e.g., developer-generated rules, system defined rules, etc.) and patterns 234 (e.g., statistical patterns, developer-generated patterns, etc.), to select adaptive utterances in response to the user input.

The classifier 210 may develop and/or employ a model using machine learning algorithms to consider prior user behavior data 236, rules 232, and patterns 234, to characterize the user input and generate a classification of the user input. The classifier 210 may employ regression analysis, maximum entropy modeling, or another appropriate machine learning algorithm. The machine learning algorithm of the classifier 210 may consider prior user behavior data 236, including but not limited to frequency of use (e.g., of speech registers, word parts, words, word sequences, and the like), linguistic choices (e.g., word choice, style, phonetic reduction/enhancement, pitch, stress, length), quantity and nature of successful and unsuccessful interactions, and user settings (e.g., concerning the NLI or any other setting for a computing device for which the NLI is provided). Rules 232 and patterns 234 may also be factors considered and/or utilized in the machine learning algorithm of the classifier 210. Using the machine learning algorithm, the classifier 210 may develop a model that may characterize the user input (and potentially the user). Based on these considered factors (and potentially the model), the classifier 210 can characterize the user input and/or generate a classification for the user input.

As an example of a classification, the classifier 210 may characterize a given speech input as “formal” and classify it using a classification that indicates “formal.” The classification may provide a degree of formality. For example, input speech such as “Hello, how do you do?” may be classified as “formal,” whereas input speech such as “Hi” may be classified as “informal.”

The classifier 210 may communicate the user input and the classification to the dialogue manager. The user input may be communicated as, for example, a literal string (e.g., text). In other embodiments, the user input may be communicated as a waveform (e.g., of input speech).

The dialogue manager 220 uses the user input and the classification to select adaptive utterances as a response to the user input. The adaptive utterances may be adaptive because, based on the classification (generated with consideration of prior user behavior data 236 and other considerations), they include changes to one or more of a word choice, speech register(s), verbosity, simplicity or complexity of procedures and/or interactions, and/or assumption(s) regarding information.

In some embodiments, the dialogue manager 220 may execute one or more commands, and/or include a command execution engine to execute one or more commands based on the user input. For example, the dialogue manager 220 may, for example, launch another application (e.g., an email client, a map application, an SMS text client, a browser, etc.), interact with other systems and/or system components, query a network (e.g., the Internet), and the like. In other words, the dialogue manager 220 may derive meaning from the user input.

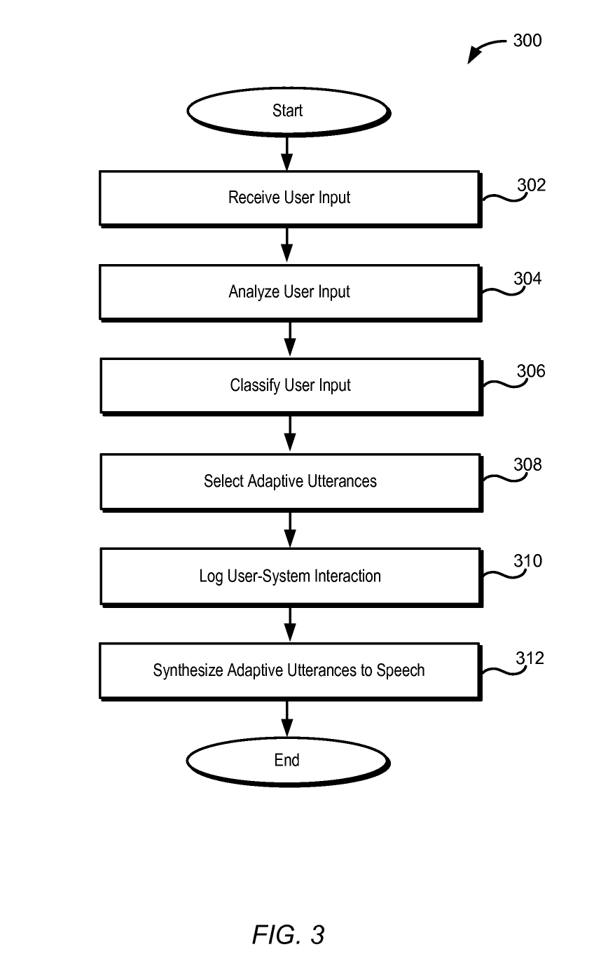

FIG. 3 is a flow diagram of a method 300 for providing a user adaptive NLI, according to one embodiment of the present disclosure. User input may be received 302, thereby initiating a user-system interaction. The user input may be input speech, input text, or a combination thereof. Receiving 302 the user input may include speech to text conversion to convert input speech to text. The user input may be analyzed 304 to derive current user behavior data. The current user behavior data may include data indicative of characteristics and/or linguistic features of the user input, such as speech registers. The current user behavior data may also include identification of linguistic choices, including but not limited to word choice, style, phonetic reduction or enhancement, pitch, stress, and length.

The user input may be characterized and/or classified 306 based on prior user behavior data previously logged during one or more previous user-system interactions and the current user behavior data. The classifying 306 may include generating a classification of the user input. The prior user behavior data may including data indicative of characteristics and/or linguistic features of user input during the one or more previous user-system interactions, such as speech registers. The current user behavior data may also include identification of linguistic choices, including but not limited to word choice, style, phonetic reduction or enhancement, pitch, stress, and length.

The classifying 306 may include processing the user input using a machine learning algorithm that considers the prior user behavior data and the current user behavior data. The machine learning algorithm may be any suitable machine learning algorithm, such as maximum entropy, regression analysis, or the like. The classifying 306 may include considering statistical patterns of linguistic features (e.g., speech registers) inferred from the user input. The classifying 306 may include considering prior user behavior data and current user behavior data including user linguistic choices to determine a classification of the user input. The classifying 306 may include considering user settings to determine a classification of the user input. The classifying 306 may include considering rules to determine a classification of the user input.

User adaptive utterances can be selected 308 based on the user input and the classification of the user input. The user adaptive utterances can be selected 308, based on the classification of the user input, to include one or more of a speech register, a changed verbosity, a simplification (e.g., omitting one or more portions of a typical response), and/or an assumption of additional input (e.g., a frequently selected choice, a user setting of a system parameter) not otherwise provided with the user input.

The user-system interaction may be logged 310. The logged 310 information may include current user behavior data. The logged 310 information may include updated user behavior data, based on the prior user behavior data and the current user behavior data. The logged 310 current user behavior data then becomes, in a future user-system interaction, prior user behavior data that may be considered for classifying 306 user input during the future user-system interaction.

A response to the user input may be generated, which may include synthesizing 312 output speech from the user adaptive utterances selected. Output speech synthesis 312 may include concatenating pieces of recorded speech, for example, that may be stored in a database. The pieces of stored recorded speech may correspond to words and/or word portions corresponding to potential adaptive utterances. Speech synthesis 312 may include retrieving or otherwise accessing stored recordings of speech units (e.g., complete words and/or word parts, such as phones or diphones) and concatenating the recordings together to generate synthesized speech.

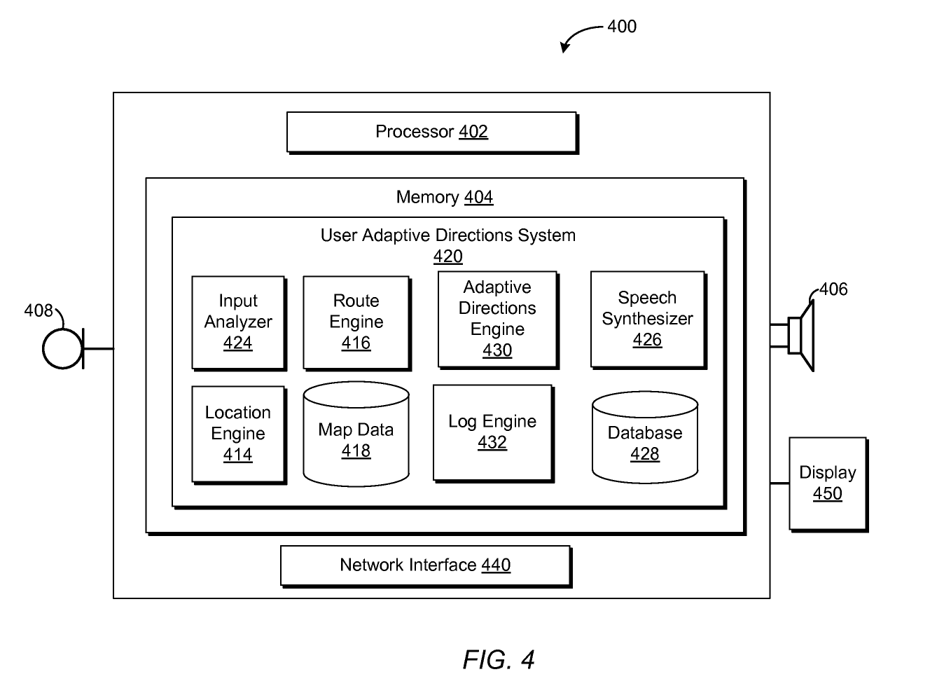

FIG. 4 is a schematic diagram of a system 400 for providing user adaptive directions in a navigation system, according to one embodiment of the present disclosure. The adaptive directions may be presented in a variety of output forms, including but not limited to via a visual display and/or via a natural language interface. The system 400 can adapt a level of direction detail according to the user's familiarity with the route being traveled. For example, the system 400 may infer that a user knows certain routes and, thus, can choose to skip turn-by-turn directions as long as the user is traveling on familiar terrain. Once the user crosses into unfamiliar territory, the system 400 may adapt and begin offering more detailed directions.

As an example, rather than instructing the user to “take a left on North First Street, take a right on Montague, merge on the 101 highway,” the system 400 can adapt the directions to simply provide “Proceed to the 101.” The directions may be presented visually via a map on a display screen, printed text on display screen, and/or audible instructions (e.g., through a NLI).

The system 400 may also learn user preferences, such as more frequently choosing a specific highway over another, or more frequently choosing local roads vs. highways, and the like. Whenever ranking possible routes, the system 400 may take such preferences into consideration and rank user-preferred routes higher.

The system 400 may also incorporate crime rate information whenever ranking alternative routes, and may prefer routes that are safer (beyond being faster and/or more familiar).

In the illustrated embodiment of FIG. 4, the system 400 may include a processor 402, memory 404, an audio output 406, an input device 408, and a network interface 440, similar to the system 100 of FIG. 1.

The system 400 of FIG. 4 may resemble the system 100 described above with respect to FIG. 1. Accordingly, like features may be designated with like reference numerals. Relevant disclosure set forth above regarding similarly identified features, thus, may not be repeated hereafter. Moreover, specific features of the system 400 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the system 400. Any suitable combination of the features and variations of the same described with respect to the system 100 can be employed with the system 400, and vice versa. This pattern of disclosure applies equally to any further embodiments depicted in subsequent figures and described hereafter.

The system 400 may include a display (e.g., a display screen, touch screen, or the like) on which to display map data, route data, and/or location data.

The system 400 may further include a user adaptive directions system 420 configured to generate user adaptive directions based on prior user behavior data (e.g., familiarity with a route or portion thereof, user preferences, etc.) and/or statistical patterns (e.g., crime rates with respect to a given area).

The user adaptive directions system 420 can provide a user adaptive output adapted for a given user and/or user input. The user adaptive directions system 420 may be a system for providing a user adaptive NLI, for example, for a navigation system. The user adaptive directions system 420 may also provide a user adaptive visual interface, such as adaptive directions presented as visual output on a display screen using a map, text, and/or other visual features.

The user adaptive directions system 420 may include an input analyzer 424, a location engine 414, a route engine 416, map data 418, an adaptive directions engine 430, a log engine 432, a speech synthesizer 426, and/or a database 428.

The input analyzer 424 may include a speech-to-text system and may receive user input, including a request for navigation directions to a desired destination. The input analyzer 424 may also derive current user behavior data, such as described above with reference to input analyzer 124 of FIG. 1. The input received by include indication of an excluded portion of a route specifying a portion of a route that can be excluded from the user adaptive navigation directions. For example, a user may be located at home and may frequently travel to the turnpike and be familiar with the route to the turnpike. The user could provide user input as a voice command such as “Directions to New York City, starting at the turnpike.” From this command, the input analyzer may determine an exclusion portion from the current location to the turnpike. The exclusion portion can be considered by the adaptive directions engine 430 when generating user adaptive navigation directions.

The location engine 414 may detect a current location. The route engine 416 may analyze map data 418 to determine potential routes from the current location to the desired destination.

The adaptive directions engine 430 may generate user adaptive directions. The adaptive directions engine 430 may consider current user behavior data and prior user behavior data to adapt output (e.g., directions) to the user. For example, the adaptive directions engine 430 may infer that a user knows certain routes and, thus, can select adaptive visual cues and/or utterances (e.g., directions) that skip turn-by-turn directions as long as the user is traveling on familiar terrain. Once the user crosses into unfamiliar territory, the adaptive directions engine 430 may adapt and begin selecting adaptive output that provides more detailed directions. The user behavior considered may include frequency of use or occurrence of linguistic features, linguistic content, style, duration, workflow, information conveyed, an excluded portion of a route, etc.

The adaptive directions engine 430 may develop and/or employ a model using machine learning algorithms. For example, the adaptive directions engine 430 may employ regression analysis, maximum entropy modelling, or another appropriate machine learning algorithm. The model may allow the system 400 to adapt its behavior for the given user. The model may consider, for example, usage patterns (e.g., frequent routes, familiar areas), linguistic choices made by the user, quantity and/or nature of successful and unsuccessful interactions, and user settings. Based on these factors, the user adaptive directions system 420 may be able to adapt to a user by, for example, changing visual cues, changing word choice, changing speech register(s), changing verbosity, simplifying procedures and/or interactions (e.g., route directions), and/or assuming input unless provided otherwise.

The adaptive directions engine 430 can further use the generated model to facilitate route selection from among potential routes identified by the route engine 416. As described above the adaptive directions engine 430 may rank potential routes (or otherwise facilitate route selection) based on learned user preferences, such as more frequently chosen highways (or other portions of routes), more frequently choosing a type of route portion (e.g., local roads vs. highways), and user settings (e.g., always take the shortest route based on time (minutes of travel), rather than distance).

The adaptive directions engine 430 may also incorporate other statistical pattern information, such as crime rate information, toll fees, construction, and the like, to rank alternative routes, and may prefer routes that are safer (beyond being faster and/or more familiar), less expensive, or the like.

The speech synthesizer 426 can synthesize speech from the selected adaptive directions selected by the adaptive directions engine 430. The speech synthesizer 426 may include any appropriate speech synthesis technology. The speech synthesizer 426 may generate synthesized speech by concatenating pieces of recorded speech that are stored in the database 428. The pieces of recorded speech stored in the database 428 may correspond to words and/or word portions corresponding to potential adaptive directions. The speech synthesizer 426 may retrieve or otherwise access stored recordings of speech units (e.g., complete words and/or word parts, such as phones or diphones) stored in the database 428 and concatenate the recordings together to generate synthesized speech. The speech synthesizer 426 may be configured to convert text adaptive utterances into synthesized speech.

As can be appreciated, user adaptive utterances can be utilized in a variety of applications, and not just the embodiments described above. Another application may include media distribution applications.

### EXAMPLE EMBODIMENTS

Some examples of embodiments of adaptive natural language interfaces and other adaptive output systems are provided below.

### Example 1

A system for providing a user adaptive natural language interface, comprising: an input analyzer to analyze user input to derive current user behavior data, wherein the current user behavior data includes linguistic features of the user input; a classifier to consider prior user behavior data and the current user behavior data and determine a classification of the user input; a dialog manager to select user adaptive utterances based on the user input and the classification of the user input; a log engine to log a current user-system interaction, including current user behavior data; and a speech synthesizer to synthesize output speech from the selected user adaptive utterances as an audible response.

### Example 2

The system of example 1, wherein the input analyzer comprises a speech-to-text subsystem to receive speech user input and convert the speech user input to text to analyze for user behavior data.

### Example 3

The system of any of examples 1-2, wherein the classifier considers prior user behavior data and current user behavior data including statistical patterns of linguistic features to determine a classification of the user input, the statistical patterns inferred from the user input.

### Example 4

The system of example 3, wherein the linguistic features comprise speech registers.

### Example 5

The system of any of examples 1-4, wherein the classifier considers prior user behavior data and current user behavior data including user linguistic choices to determine a classification of the user input.

### Example 6

The system of any of examples 1-5, wherein the classifier further considers user settings to determine a classification of the user input.

### Example 7

The system of any of examples 1-6, wherein the classifier further considers developer-generated rules to determine the classification of the user input.

### Example 8

The system of any of examples 1-7, wherein the classifier includes a machine learning algorithm to consider the current user behavior with context of the prior user behavior to determine the classification of the user input.

### Example 9

The system of example 8, wherein the machine learning algorithm of the classifier includes one of maximum entropy and regression analysis.

### Example 10

The system of any of examples 1-9, wherein the user adaptive utterances selected by the dialog manager are adaptive to the user input by including a speech register selected based on the classification of the user input.

### Example 11

The system of any of examples 1-10, wherein the user adaptive utterances selected by the dialog manager are adaptive to the user input by including a verbosity selected based on the classification of the user input.

### Example 12

The system of any of examples 1-11, wherein the user adaptive utterances selected by the dialog manager are adaptive to the user input by simplifying the user interaction.

### Example 13

The system of example 12, wherein the user adaptive utterances simplify the user interaction by omitting one or more portions of a typical response.

### Example 14

The system of any of examples 1-13, wherein the user adaptive utterances selected by the dialog manager are adaptive to the user input by including an assumption of additional input not otherwise provided with the user input.

### Example 15

The system of example 14, wherein the additional input assumed includes a frequently selected choice.

### Example 16

The system of example 14, wherein the additional input assumed includes a user setting of a system parameter.

### Example 17

The system of any of examples 1-16, further comprising a speech-to-text subsystem to receive speech user input and convert the speech user input to text for the input analyzer to analyze.

### Example 18

The system of any of examples 1-17, wherein the dialog manager comprises a command execution engine to execute a command on the system based on the user input.

### Example 19

The system of any of examples 1-18, wherein the input analyzer is further configured to derive a meaning of the user input.

### Example 20

The system of any of examples 1-19, wherein logging the current user behavior data comprises logging updated user behavior data, based on the prior user behavior data and the current user behavior data.

### Example 21

A computer-implemented method for providing a user adaptive natural language interface, comprising: receiving on one or more computing devices user input to initiate a user-system interaction; analyzing on the one or more computing devices the user input to derive current user behavior data, including data indicative of characteristics of the user input; classifying on the one or more computing devices the user input based on prior user behavior data previously logged during one or more previous user-system interactions and the current user behavior data to generate a classification of the user input, the prior user behavior data including data indicative of characteristics of user input during the one or more previous user-system interactions; selecting user adaptive utterances based on the user input and the classification of the user input; logging on the one or more computing devices the user-system interaction, including the current user behavior data; and generating a response to the user input, including synthesizing output speech from the user adaptive utterances selected.

### Example 22

The method of example 21, wherein classifying includes processing on the one or more computing devices the user input using a machine learning algorithm that considers the prior user behavior data and the current user behavior data.

### Example 23

The method of example 22, wherein the machine learning algorithm is one of maximum entropy and regression analysis.

### Example 24

The method of any of examples 21-23, wherein classifying includes considering statistical patterns of linguistic features to classify the user input, the statistical patterns inferred from the user input.

### Example 25

The method of example 24, wherein the linguistic features comprise speech registers.

### Example 26

The method of any of examples 21-25, wherein classifying includes considering prior user behavior data and current user behavior data including user linguistic choices to determine a classification of the user input.

### Example 27

The method of any of examples 21-26, wherein classifying includes considering user settings to determine a classification of the user input.

### Example 28

The method of any of examples 21-27, wherein classifying includes considering rules to determine a classification of the user input.

### Example 29

The method of any of examples 21-28, wherein the user adaptive utterances include a speech register selected based on the classification of the user input.

### Example 30

The method of any of examples 21-29, wherein the user adaptive utterances include a changed verbosity selected based on the classification of the user input.

### Example 31

The method of any of examples 21-30, wherein the user adaptive utterances simplify the user interaction based on the classification of the user input.

### Example 32

The method of example 31, wherein the user adaptive utterances simplify the user interaction by omitting one or more portions of a typical response.

### Example 33

The method of any of examples 21-32, wherein the user adaptive utterances are selected based on an assumption of additional input not otherwise provided with the user input.

### Example 34

The method of example 33, wherein the assumption of additional input includes a frequently selected choice.

### Example 35

The method of example 33, wherein the additional input assumed includes a user setting of a system parameter.

### Example 36

The method of any of examples 21-35, wherein receiving user input includes converting speech user input to text for analyzing to derive current user behavior.

### Example 37

The method of any of examples 21-36, wherein analyzing the user input further includes deriving a meaning of the user input.

### Example 38

The method of any of examples 21-37, wherein logging the current user behavior data comprises logging updated user behavior data, based on the prior user behavior data and the current user behavior data.

### Example 39

A computer-readable medium having stored thereon instructions that, when executed by a processor, cause the processor to perform operations for providing a user adaptive natural language interface, the operations comprising: receiving on one or more computing devices user input to initiate a user-system interaction; analyzing on the one or more computing devices the user input to derive current user behavior data, including data indicative of characteristics of the user input; classifying on the one or more computing devices the user input based on prior user behavior data previously logged during one or more previous user-system interactions and the current user behavior data to generate a classification of the user input, the prior user behavior data including data indicative of characteristics of user behavior during the one or more previous user-system interactions; selecting user adaptive utterances based on the user input and the classification of the user input; logging on the one or more computing devices the user-system interaction, including the current user behavior data; and generating a response to the user input, including synthesizing output speech from the user adaptive utterances selected.

### Example 40

The computer-readable medium of example 39, wherein classifying includes processing on the one or more computing devices the user input using a machine learning algorithm that considers the prior user behavior data and the current user behavior data.

### Example 41

The computer-readable medium of example 40, wherein the machine learning algorithm is one of maximum entropy and regression analysis.

### Example 42

The computer-readable medium of any of examples 39-41, wherein classifying includes considering statistical patterns of linguistic features to classify of the user input, the statistical patterns inferred from the user input.

### Example 43

The computer-readable medium of example 42, wherein the linguistic features comprise speech registers.

### Example 44

The computer-readable medium of any of examples 39-43, wherein classifying includes considering prior user behavior data and current user behavior data including user linguistic choices to determine a classification of the user input.

### Example 45

The computer-readable medium of any of examples 39-44, wherein classifying includes considering user settings to determine a classification of the user input.

### Example 46

The computer-readable medium of any of examples 39-45, wherein classifying includes considering rules to determine a classification of the user input.

### Example 47

The computer-readable medium of any of examples 39-46, wherein the user adaptive utterances include a speech register selected based on the classification of the user input.

### Example 48

The computer-readable medium of any of examples 39-47, wherein the user adaptive utterances include a changed verbosity selected based on the classification of the user input.

### Example 49

The computer-readable medium of any of examples 39-48, wherein the user adaptive utterances simplify the user interaction based on the classification of the user input.

### Example 50

The computer-readable medium of example 49, wherein the user adaptive utterances simplify the user interaction by omitting one or more portions of a typical response.

### Example 51

The computer-readable medium of any of examples 39-50, wherein the user adaptive utterances are selected based on an assumption of additional input not otherwise provided with the user input.

### Example 52

The computer-readable medium of example 51, wherein the assumption of additional input includes a frequently selected choice.

### Example 53

The computer-readable medium of example 51, wherein the additional input assumed includes a user setting of a system parameter.

### Example 54

The computer-readable medium of any of examples 39-53, wherein receiving user input includes converting speech user input to text for analyzing to derive current user behavior.

### Example 55

The computer-readable medium of any of examples 39-54, wherein analyzing the user input further includes deriving a meaning of the user input.

### Example 56

The computer-readable medium of any of examples 39-55, wherein logging the current user behavior data comprises logging updated user behavior data, based on the prior user behavior data and the current user data.

### Example 57

A navigation system providing user adaptive navigation directions, comprising: an input analyzer to analyze user input to derive a request for directions to a desired destination and to derive current user behavior data, wherein the current user behavior data includes data indicative of characteristics of the user input; map data providing map information; a route engine to generate a route from a first location to the desired destination using the map information; an adaptive directions engine to generate user adaptive navigation directions by considering prior user behavior data and the current user behavior data to determine a classification of the user input and selecting user adaptive navigation directions based on the user input, the classification of the user input, and/or user familiarity with a given territory along the route; and a log engine to log a current user-system interaction, including current user behavior data. The navigation system may include a display on which to present user adaptive navigation directions. The navigation system may further include a speech synthesizer to synthesize output speech from the selected user adaptive directions as an audible response.

### Example 58

The navigation system of example 57, further comprising a location engine to determine a current location of the navigation system, wherein the dialogue manager further selects user adaptive navigation directions based on the current location of the navigation system, and wherein the speech synthesizer converts to speech output the selected adaptive navigation directions based on the current location of the navigation system.

### Example 59

The navigation system of any of examples 57-58, wherein the route engine generates a plurality of potential routes from the first location to the desired destination using the map information, and wherein the adaptive directions engine ranks the plurality of potential routes and selects user adaptive navigation directions for a highest ranked potential route of the plurality of potential routes.

### Example 60

The navigation system of example 59, wherein the adaptive directions engine ranks the plurality of potential routes based, at least in part, on user preferences.

### Example 61

The navigation system of example 59, wherein the adaptive directions engine ranks the plurality of potential routes based, at least in part, on crime rate in areas along each of the plurality of potential routes.

### Example 62

The navigation system of claim 57, wherein the user input includes an excluded portion of the route to exclude from the user adaptive navigation directions, and wherein the adaptive directions engine generates the user adaptive navigation directions that omit directions relative to the excluded portion of the route. The user input may be speech input, including spoken indication of the excluded portion

### Example 63

A method of providing user adaptive navigation directions, the method comprising: receiving on one or more computing devices user input including a request for navigation directions to initiate a user-system interaction; analyzing on the one or more computing devices the user input to derive a desired destination and to derive current user behavior data; generating a route from a first location to the desired destination using map information; classifying on the one or more computing devices the user input based on prior user behavior data previously logged during one or more previous user-system interactions and the current user behavior data to generate a classification of the user input, the prior user behavior data including data indicative of user familiarity with a given territory along the route, wherein the classification reflects the user familiarity with a given territory along the route; selecting user adaptive navigation directions based on the user input and the classification of the user input, including the user familiarity with a given territory along the route; logging on the one or more computing devices the user-system interaction, including the current user behavior data; and generating a response to the user input, including synthesizing output speech from the user adaptive navigation directions selected.

### Example 64

The method of example 63, further comprising determining a present location, wherein the user adaptive navigation directions are selected based, in part, on the current location of the navigation system, and wherein the user adaptive navigation directions are synthesized to output speech based on the current location of the navigation system.

### Example 65

The method of any of examples 61-64, wherein generating a route comprises generating a plurality of potential routes from the first location to the desired destination using the map information, the method further comprising: ranking the plurality of potential routes, wherein the user adaptive navigation directions are selected for a highest ranked potential route of the plurality of potential routes.

### Example 66

The method of example 65, wherein the ranking of the plurality of potential routes is based, at least in part, on user preferences.

### Example 67

The method of example 65, wherein the ranking of the plurality of potential routes is based, at least in part, on crime rate in areas along each of the plurality of potential routes.

### Example 68

A system comprising means to implement the method of any one of examples 21-38 and 62-67.

### Example 69

A system for providing a user adaptive natural language interface, comprising: means for analyzing user input to derive current user behavior data, wherein the current user behavior data includes linguistic features of the user input; means for classifying the user input based on the prior user behavior data and the current user behavior data; means for selecting user adaptive utterances based on the user input and the classification of the user input; means for logging a current user-system interaction, including current user behavior data; and means for synthesizing output speech from the selected user adaptive utterances as an audible response.

### Example 70

The system of example 69, wherein the classifying means considers prior user behavior data and current user behavior data including statistical patterns of linguistic features to determine a classification of the user input, the statistical patterns inferred from the user input.

### Example 71

A system for providing a user adaptive natural language interface, comprising: an input analyzer to analyze user input to derive current user behavior data, wherein the current user behavior data includes linguistic features of the user input; a classifier to consider prior user behavior data and the current user behavior data and determine a classification of the user input; a log engine to log a current user-system interaction, including current user behavior data; and a dialog manager to present user adaptive utterances based on the user input and the classification of the user input.

### Example 72

The system of Example 71, wherein the classifier considers prior user behavior data and current user behavior data including statistical patterns of linguistic features to determine a classification of the user input, the statistical patterns inferred from the user input.

### Example 73

The system of Example 71, wherein the classifier further considers at least one of user settings and developer-generated rules to determine a classification of the user input.

### Example 74

The system of Example 71, wherein the input analyzer analyzes user input to derive a request for navigation directions to a desired location and wherein the user adaptive utterances are user adaptive navigation directions.

### Example 75

The system of Example 71, further comprising a speech synthesizer to synthesize output speech from the selected user adaptive utterances as an audible response.

The above description provides numerous specific details for a thorough understanding of the embodiments described herein. However, those of skill in the art will recognize that one or more of the specific details may be omitted, or other methods, components, or materials may be used. In some cases, well-known features, structures, or operations are not shown or described in detail.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

We claim:

1. A navigation system providing user adaptive navigation directions, comprising:
an input analyzer to analyze user input to derive a request for directions to a desired destination and to derive current user behavior data;
map data providing map information;
a route engine to generate a route from a first location to the desired destination using the map information;
a log engine to log a current user-system interaction, including current user behavior data; and
an adaptive directions engine to generate and present user adaptive navigation directions, by considering prior user behavior data and the current user behavior data to determine a classification of the user input and selecting user adaptive navigation directions based on the user input and the classification of the user input.

2. The navigation system of claim 1, wherein the classification of the user input includes user familiarity with a given territory along the route, wherein the user familiarity is derived from the prior user behavior data.

3. The navigation system of claim 1, further comprising a display, wherein the adaptive directions engine presents the user adaptive navigation directions as visual output via the display.

4. The navigation system of claim 3, wherein the visual output includes one or more of map data, route data, and text data.

5. The navigation system of claim 1, further comprising a natural language interface to present the user adaptive navigation directions as natural language output.

6. The navigation system of claim 5, wherein the natural language interface includes a speech synthesizer to synthesize audible output speech from the selected user adaptive directions to present through the natural language interface.

7. The navigation system of claim 1, further comprising a location engine to determine a current location of the navigation system, wherein the dialogue manager further selects user adaptive navigation directions based on the current location of the navigation system, and wherein the speech synthesizer converts to speech output the selected adaptive navigation directions based on the current location of the navigation system.

8. The navigation system of claim 1, wherein the route engine generates a plurality of potential routes from the first location to the desired destination using the map information, and
wherein the adaptive directions engine ranks the plurality of potential routes and selects user adaptive navigation directions for a highest ranked potential route of the plurality of potential routes.

9. The navigation system of claim 8, wherein the adaptive directions engine ranks the plurality of potential routes based, at least in part, on user preferences.

10. The navigation system of claim 8, wherein the adaptive directions engine ranks the plurality of potential routes based, at least in part, on crime rate in areas along each of the plurality of potential routes.

11. The navigation system of claim 1, wherein the user input includes an indication of an excluded portion of the route to exclude from the user adaptive navigation directions, and wherein the adaptive directions engine generates the user adaptive navigation directions that omit directions relative to the excluded portion of the route.

12. The navigation system of claim 11, wherein the user input comprises input speech, including spoken indication of the excluded portion.

13. A method of providing user adaptive navigation directions, the method comprising:
receiving on one or more computing devices user input including a request for navigation directions to initiate a user-system interaction;
analyzing on the one or more computing devices the user input to derive a desired destination and to derive current user behavior data;
generating a route from a first location to the desired destination using map information;
classifying on the one or more computing devices the user input based on prior user behavior data previously logged during one or more previous user-system interactions and the current user behavior data to generate a classification of the user input;
selecting user adaptive navigation directions based on the user input and the classification of the user input;
logging on the one or more computing devices the user-system interaction, including the current user behavior data; and
generating an output response to the user input, the output response including the selected user adaptive navigation direction.

14. The method of claim 13, wherein the classification of the user input includes user familiarity with a given territory along the route, wherein the user familiarity is derived from the prior user behavior data.

15. The method of claim 13, wherein generating an output response includes presenting the selected user adaptive navigation directions as visual output on a display screen.

16. The method of claim 15, wherein the visual output includes one or more of map data, route data, and text data.

17. The method of claim 13, wherein generating an output response includes synthesizing output speech from the selected user adaptive navigation directions.

18. The method of claim 13, further comprising determining a present location, wherein the selecting the user adaptive navigation directions is based, in part, on the current location of the navigation system.

19. The method of claim 13, wherein generating a route comprises generating a plurality of potential routes from a first location to a desired destination using the map information, the method further comprising:
ranking the plurality of potential routes,
wherein the user adaptive navigation directions are selected for a highest ranked potential route of the plurality of potential routes.

20. The method of claim 19, wherein the ranking of the plurality of potential routes is based, at least in part, on user preferences.

21. The method of claim 19, wherein the ranking of the plurality of potential routes is based, at least in part, on crime rate in areas along each of the plurality of potential routes.

22. The method of claim 13, wherein the user input indicates an excluded portion of the route to exclude from the user adaptive navigation directions, and wherein the selected user adaptive navigation directions omit directions relative to the excluded portion of the route.

23. At least one computer-readable medium having stored thereon instructions that, when executed by a processor, cause the processor to perform operations for providing user adaptive navigation directions, the operations comprising:
receiving on one or more computing devices user input including a request for navigation directions to initiate a user-system interaction;
analyzing on the one or more computing devices the user input to derive a desired destination and to derive current user behavior data;
generating a route from a first location to the desired destination using map information;
classifying on the one or more computing devices the user input based on prior user behavior data previously logged during one or more previous user-system interactions and the current user behavior data to generate a classification of the user input;
selecting user adaptive navigation directions based on the user input and the classification of the user input;
logging on the one or more computing devices the user-system interaction, including the current user behavior data; and
generating an output response to the user input, the output response including the selected user adaptive navigation direction.

24. The computer-readable medium of claim 23, wherein generating an output response includes presenting the selected user adaptive navigation directions as visual output on a display screen.

25. The computer-readable medium of claim 23, wherein generating an output response includes synthesizing output speech from the selected user adaptive navigation directions.

26. A system for providing a user adaptive natural language interface, comprising:
an input analyzer to analyze user input to derive current user behavior data, wherein the current user behavior data includes linguistic features of the user input;
a classifier to consider prior user behavior data and the current user behavior data and determine a classification of the user input;
a log engine to log a current user-system interaction, including current user behavior data; and
a dialog manager to present user adaptive utterances based on the user input and the classification of the user input.

27. The system of claim 26, wherein the classifier considers prior user behavior data and current user behavior data including statistical patterns of linguistic features to determine a classification of the user input, the statistical patterns inferred from the user input.

28. The system of claim 26, wherein the classifier further considers at least one of user settings and developer-generated rules to determine a classification of the user input.

29. The system of claim 26, wherein the input analyzer analyzes user input to derive a request for navigation directions to a desired location and wherein the user adaptive utterances are user adaptive navigation directions.

30. The system of claim 26, further comprising a speech synthesizer to synthesize output speech from the selected user adaptive utterances as an audible response.
